(19) United States
(12) Patent Application Publication
(10) Pub. No.: US 2020/0019351 A1
(43) Pub. Date: Jan. 16, 2020

(54) IMAGE FORMING APPARATUS AND METHOD FOR CONTROLLING THE SAME

(71) Applicant: SHARP KABUSHIKI KAISHA, Sakai City (JP)

(72) Inventor: YOSHIKAZU KONDOH, Sakai City (JP)

(21) Appl. No.: 16/507,573

(22) Filed: Jul. 10, 2019

(30) Foreign Application Priority Data
Jul. 11, 2018 (JP) 2018-131559

(51) Int. Cl. G06F 3/12; G06F 3/041; H04N 1/00

(52) U.S. Cl. CPC G06F 3/1204; G06F 3/1285; H04N 1/00427; G06F 3/0416; G06F 3/0412

(57) ABSTRACT

An image forming apparatus includes a CPU and a display with a touch panel. A file list screen including a file list obtained from an external computer or an external memory is displayed on the display. When the file list screen is displayed, whether files corresponding to file names are printable and whether printable files have been printed are determined, and results of the determinations are indicated.

### BACKGROUND

### 1. Field

The present disclosure relates to an image forming apparatus and a method for controlling the image forming apparatus.

### 2. Description of the Related Art

Japanese Patent No. 5489792 discloses an example of the related art. In an image processing system in this example, a web application performs a process for generating an operation screen to be transmitted to a web browser on the basis of information that can be obtained from an external service. The web application obtains types of format of image data (file) printable by a printing unit, and download buttons are displayed for printable files while being associated with file names of the printable files. For unprintable files, however, only file names are displayed. If one of the download buttons is pressed, the corresponding file is downloaded from the external service, and the pressed download button is replaced by a print button or the like.

### SUMMARY

With the image processing system in the example of the related art, however, a user can only know whether information that can be obtained from an external service is downloadable and printable. There is yet room for improvement in usability.

The present disclosure provides a novel image forming apparatus and a novel method for controlling the image forming apparatus.

The present disclosure also provides an image forming apparatus and a method for controlling the image forming apparatus capable of improving usability.

According to an aspect of the disclosure, there is provided an image forming apparatus that displays identification information regarding a plurality of files on a display unit and that outputs a file selected by a user. The image forming apparatus includes a printing history determination unit that determines whether each of the plurality of files has been printed and a display control unit that displays, on the display unit, the identification information regarding each of the plurality of files, the identification information visually indicating a result of a determination made by the printing history determination unit.

According to another aspect of the disclosure, there is provided an image forming apparatus that displays identification information regarding a plurality of files on a display unit and that outputs a file selected by a user. The image forming apparatus includes an access history determination unit that determines whether each of the plurality of files has been accessed and a display control unit that displays, on the display unit, the identification information regarding each of the plurality of files, the identification information visually indicating a result of a determination made by the access history determination unit.

According to another aspect of the disclosure, there is provided a method for controlling an image forming apparatus that displays identification information regarding a plurality of files on a display unit and that outputs a file selected by a user. The method includes determining whether each of the plurality of files has been printed and displaying, on the display unit, the identification information regarding each of the plurality of files, the identification information visually indicating a result of a determination made by the printing history determination unit.

According to another aspect of the disclosure, there is provided a method for controlling an image forming apparatus that displays identification information regarding a plurality of files on a display unit and that outputs a file selected by a user. The method includes determining whether each of the plurality of files has been accessed and displaying, on the display unit, the identification information regarding each of the plurality of files, the identification information visually indicating a result of a determination made by the access history determination unit.

Characteristics and benefits of the present disclosure will become more apparent in the following detailed description of the embodiments and the accompanying drawings.

### BRIEF DESCRIPTION OF THE DRAWINGS

FIG. 1 is a perspective view illustrating the appearance of an image forming apparatus according to an embodiment of the present disclosure;

FIG. 2 is a block diagram illustrating the electrical configuration of the image forming apparatus illustrated in FIG. 1;

FIG. 3 is a diagram illustrating a first example of a file list screen;

FIG. 4 is a diagram illustrating a first example of a dialog box;

FIG. 5 is a diagram illustrating a first example of a memory map of a random-access memory (RAM) illustrated in FIG. 2;

FIG. 6 is a flowchart illustrating a first example of a process for displaying a list performed by a central processing unit (CPU) illustrated in FIG. 2;

FIG. 7 is a flowchart illustrating a first example of a process for controlling printing performed by the CPU illustrated in FIG. 2;

FIG. 8 is a diagram illustrating a second example of the file list screen;

FIG. 9 is a diagram illustrating a second example of the memory map of the RAM illustrated in FIG. 2;

FIG. 10 is a flowchart illustrating a part of a second example of the process for displaying a list performed by the CPU illustrated in FIG. 2;

FIG. 11 is a diagram illustrating a third example of the file list screen;

FIG. 12 is a flowchart illustrating a part of a third example of the process for displaying a list performed by the CPU illustrated in FIG. 2;

FIG. 13 is a diagram illustrating a fourth example of the file list screen;

FIG. 14 is a flowchart illustrating a part of a fourth example of the process for displaying a list performed by the CPU illustrated in FIG. 2;

FIG. 15 is a diagram illustrating a fifth example of the file list screen;

FIG. 16 is a flowchart illustrating a part of a fifth example of the process for displaying a list performed by the CPU illustrated in FIG. 2;

FIG. 17 is a diagram illustrating a sixth example of the file list screen;

FIG. 18 is a flowchart illustrating a part of a sixth example of the process for displaying a list performed by the CPU illustrated in FIG. 2;

FIG. 19 is a flowchart illustrating a part of a seventh example of the process for displaying a list performed by the CPU illustrated in FIG. 2;

FIG. 20 is a diagram illustrating a seventh example of the file list screen;

FIG. 21 is a diagram illustrating a second example of the dialog box;

FIG. 22 is a flowchart illustrating a part of an eighth example of the process for displaying a list performed by the CPU illustrated in FIG. 2; and

FIG. 23 is a flowchart illustrating a second example of the process for controlling printing performed by the CPU illustrated in FIG. 2.

### DESCRIPTION OF THE EMBODIMENTS

### First Embodiment

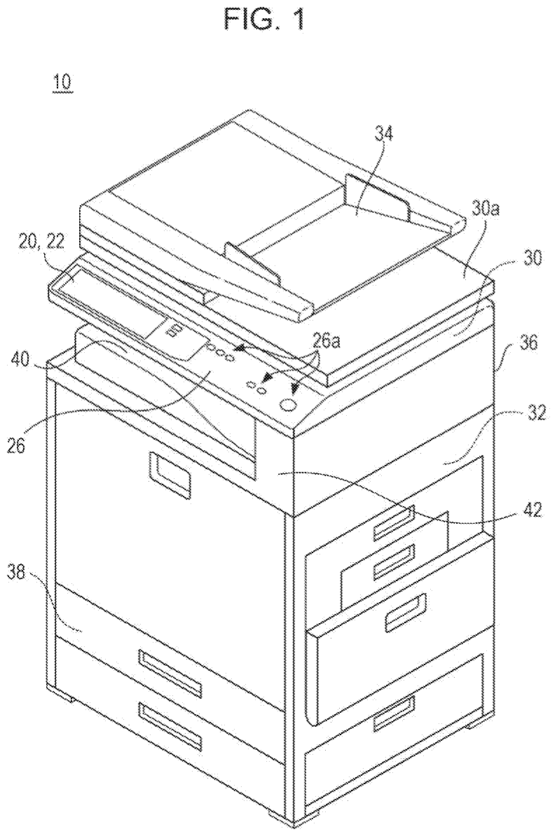

FIG. 1 is a perspective view illustrating the appearance of an image forming apparatus 10 according to an embodiment of the present disclosure. In the first embodiment, the image forming apparatus 10 is a multifunction peripheral (MFP) having a copying function, a printing function, a scanning function, a facsimile function, and the like as illustrated in FIG. 1. The present disclosure may be applied not only to an MFP but also to another image forming apparatus having at least a printing function.

A side of the image forming apparatus 10 at which a user is supposed to stand, that is, a side of the image forming apparatus 10 on which an operation panel 26, which will be described later, is provided, is herein defined as a front side of the image forming apparatus 10. A fore-and-aft direction (depth direction) and a left-and-right direction (lateral direction) of the image forming apparatus 10 and the components of the image forming apparatus 10 are accordingly defined from the user's point of view.

The image forming apparatus 10 includes a body 36 including an image reading unit 30, an image forming unit 32, a manual feeder unit 34, a paper feeding device 38, and a paper discharge tray 40.

The image reading unit 30 includes a document platen composed of a transparent material and is stored inside the body 36. A document holding cover 30a is openably mounted on the document platen through hinges or the like. The document holding cover 30a is provided with the manual feeder unit 34. The document holding cover 30a is also provided with an automatic document feeder (ADF), which automatically feeds a document set in the manual feeder unit 34.

The image reading unit 30 includes a light source, a plurality of mirrors, a focusing lens, and a line sensor. The image reading unit 30 illuminates a surface of a document using the light source and guides light reflected from the surface of the document to the focusing lens using the plurality of mirrors. The focusing lens then forms, from the reflected light, an image on light receiving devices of the line sensor. The light receiving devices of the line sensor detect levels of luminance or chroma of the reflected light thereon and generate image data based on an image of the surface of the document. Charge-coupled devices (CCDs) or contact image sensors (CISs), for example, are used for the line sensor.

The image forming unit 32 is stored inside the body 36 and provided under the image reading unit 30. The image forming unit 32 includes photosensitive drums, charging devices, exposing devices, developing devices, transfer devices, and a fixing device. The image forming unit 32 forms an image on a recording medium (sheet) conveyed from the manual feeder unit 34, the paper feeding device 38, or the like through electrophotography and discharges, onto the paper discharge tray 40, the sheet on which the image has been formed. As output image data for forming an image on a sheet is, for example, image data read by the image reading unit 30 or image data transmitted from an external computer. The recording medium is not limited to a sheet of paper, but may be an overhead projector (OHP) film or the like, instead.

Although detailed description is omitted, the image forming apparatus 10 has a color printing function. The image forming unit 32 includes four photosensitive drums, four charging devices, four developing devices, four intermediate transfer rollers, and four cleaning devices for yellow, magenta, cyan, and black (CMYK). An image forming station including a photosensitive drum, a charging device, a developing device, a transfer roller, and a cleaning device is provided for each color. The image forming apparatus 10 is a tandem image forming apparatus, that is, the image forming stations for the four colors are arranged in a line in the image forming unit 32.

The paper discharge tray 40 is provided between the image reading unit 30 and the image forming unit 32. A bottom surface of the paper discharge tray 40 is defined by the image forming unit 32. A top surface of the paper discharge tray 40 is defined by the image reading unit 30. A right surface (viewed from the front side) of the paper discharge tray 40 is defined by a left surface of a connection member 42. That is, a front side, a back side, and a left side of the paper discharge tray 40 are open. The bottom surface of the paper discharge tray 40 is inclined downward toward the connection member 42.

The operation panel 26 is provided on a front side of the image reading unit 30. The operation panel 26 includes a display 22 with a touch panel 20 and a plurality of operation buttons 26a.

The display 22 with the touch panel 20 displays software keys for receiving various settings and print instructions from the user, messages, and the like. The display 22 displays, for example, operation screens such as a home screen, which is a screen on which the user selects a desired job from various jobs (functions) executable by the image forming apparatus 10, and a setting screen for setting operation conditions of the jobs. A job in the first embodiment refers to a copy job (includes scanning of a document), a print job, a fax job, or the like.

The operation buttons 26a are hardware keys and include a home key, a power saving key, and a power key. The home key is used to display the home screen on the display 22. On the home screen, the user selects a job. The power saving key is used to switch between a power saving state (hereinafter referred to as a “power saving mode”) in which power consumption is reduced and a normal state (hereinafter referred to as a “normal mode”) in which power consumption is not reduced.

The software keys refer to keys or icons, for example, reproduced on the display 22 with the touch panel 20 in a software manner. The hardware keys, on the other hand, refer to physical keys or push buttons.

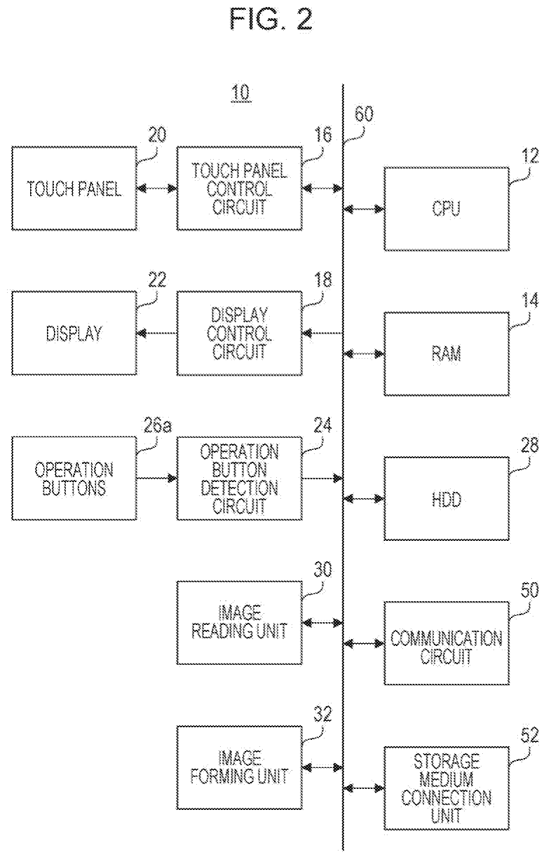

FIG. 2 is a block diagram illustrating the electrical configuration of the image forming apparatus 10 illustrated in FIG. 1. As illustrated in FIG. 2, the image forming apparatus 10 includes a CPU 12. The CPU 12 is connected to a RAM 14, a hard disk drive (HDD) 28, a touch panel control circuit 16, a display control circuit 18, an operation button detection circuit 24, the image reading unit 30, the image forming unit 32, a communication circuit 50, and a storage medium connection unit 52 through a bus 60. The touch panel control circuit 16 is connected to the touch panel 20, the display control circuit 18 is connected to the display 22, and the operation button detection circuit 24 is connected to the operation buttons 26a.

The CPU 12 controls the entirety of the image forming apparatus 10. The RAM 14 is used as a working area and a buffer area of the CPU 12. The HDD 28 is a storage device of the image forming apparatus 10 and stores control programs used by the CPU 12 to control the operation of the components of the image forming apparatus 10, display image data regarding various screens, and the like. Another nonvolatile memory such as solid-state drive (SSD), a flash memory, or an electrically erasable programmable read-only memory (EEPROM) may be used instead of, or in addition to, the HDD 28.

The touch panel control circuit 16 applies voltage to the touch panel 20 and detects a touch operation or a touch input performed within an effective touch range of the touch panel 20 to output touch coordinate data indicating a position of the touch operation or the touch input to the CPU 12.

The touch panel 20 is a general-purpose touch panel employing any method, namely, for example, a capacitive method, an electromagnetic induction method, a resistive film method, or an infrared method. In the first embodiment, a touch panel employing a capacitive method is used as the touch panel 20, and the touch panel 20 is provided on a display area of the display 22. Alternatively, a touch panel display in which the touch panel 20 and the display 22 are integrated together may be used.

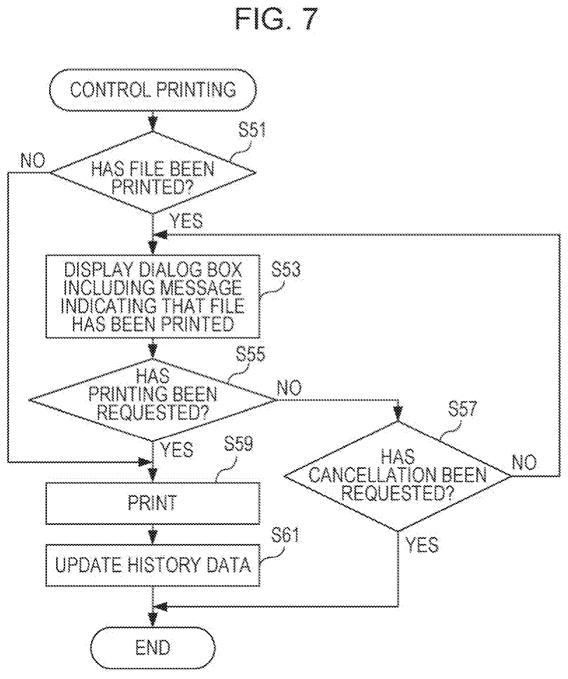

The display control circuit 18 includes a graphics processing unit (GPU) and a video RAM (VRAM). The GPU generates, in the VRAM, display image data for displaying various screens on the display 22 in accordance with an instruction from the CPU 12 using image generation data 74b (refer to FIG. 7) stored in the RAM 14 and outputs the generated display image data to the display 22. A liquid crystal display (LCD) or am electro-luminescent (EL) display, for example, may be used as the display 22.

The operation button detection circuit 24 outputs, to the CPU 12, an operation signal or operation data corresponding to an operation performed using the operation buttons 26a.

The communication circuit 50 is used to connect to a network such as the Internet. The communication circuit 50 is a wired communication circuit or a wireless communication circuit and communicates with an external computer such as a server through the network in accordance with an instruction from the CPU 12.

The storage medium connection unit 52 is a memory slot into which one of various storage media such as a secure digital (SD) card and a universal serial bus (USB) memory can be inserted. The CPU 12 reads data from a storage medium (hereinafter referred to as an “external memory”) inserted into the storage medium connection unit 52 and writes data to the external memory inserted into the storage medium connection unit 52.

The electrical configuration of the image forming apparatus 10 illustrated in FIG. 2 is an example, and another configuration may be employed, instead.

The image forming apparatus 10 can obtain a file stored in a memory of an external computer communicably connected through the network or a file stored in an external memory inserted into the storage medium connection unit 52 and perform printing.

The image forming apparatus 10 obtains identification information (file names) for identifying files from an external computer or an external memory and displays a list of the file names on the display 22. The user selects a desired file by selecting (touching) one of the file names displayed on the display 22. If the user requests printing of the selected file, the image forming apparatus 10 obtains the selected file from the external computer or the external memory and performs printing.

A memory of an external computer or an external memory includes printable files and unprintable files. Printable files herein are files in formats (hereinafter referred to as “file formats”) printable by the image forming apparatus 10, and unprintable files are files in formats unprintable by the image forming apparatus 10. Unprintable files, however, include not only files other than document, table, and image files (include photograph files) but also document, table, and image files in formats unprintable by the image forming apparatus 10.

Whether a file is printable or unprintable can be determined from an extension assigned to a file name of the file or a type of file included in properties of the file. Because extensions are not assigned to some files and correct extensions are not described for some files, however, a process for converting a file into print data is performed in the first embodiment. If print data is obtained, the file is determined as a printable file, and if print data is not obtained, the file is determined as an unprintable file. Print data refers to raster image processor (RIP) data.

The image forming apparatus 10 therefore determines, when displaying a list of file names, whether files are printable, and then displays the file names such that printable files and unprintable files are distinguished from each other.

For example, file names of printable files and file names of unprintable files are displayed in different colors. More specifically, the file names of the printable files are displayed in a default color (e.g., black), and the file names of the unprintable files are displayed in another color (e.g., red). Alternatively, the file names of the printable files may be displayed in a certain color (e.g., blue), and the file names of the unprintable files may be displayed in the default color (e.g., black). Alternatively, the file names of the printable files may be displayed in a certain color (e.g., blue), and the file names of the unprintable files may be displayed in another default color (e.g., red).

Alternatively, images and/or signs indicating whether files are printable or unprintable may be displayed along with the file names of the printable files and/or the file names of the unprintable files. More specifically, images indicating that files are printable are displayed beside the file names of the printable files, and images indicating that files are unprintable are displayed beside the file names of the unprintable files. Only the former images or the latter images may be displayed, instead. The images displayed beside the file names of the printable files and the file names of the unprintable files are icons indicating that files are printable and icons indicating that files are unprintable, respectively. In another example, the images displayed beside the file names of the printable files are thumbnail images of preview images of the printable files, and the images displayed beside the file names of the unprintable files are text images indicating that the files are unprintable. In another example, the file names of the printable files or the unprintable files may be underscored.

The list of file names can thus be displayed such that printable files and unprintable files are distinguished from each other. In the first embodiment, whether files have been printed is also indicated. More specifically, file names of printed files are grayed out. Alternatively, images (e.g., icons) indicating that files nave been printed may be displayed beside the file names.

Although not illustrated, a server for managing users (hereinafter referred to as a “management server”) is provided in the first embodiment. The management server authenticates, in accordance with an inquiry from the image forming apparatus 10, a user who is trying to use a service for printing a file stored in a memory of an external computer or an external memory and stores a history of printing of files corresponding to the user. Alternatively, a server for authenticating users and a server for storing histories may be provided separately. Alternatively, the image forming apparatus 10 may function as a management server without separately providing a management server.

If the user requests use of the service using the image forming apparatus 10, a screen for inputting a user identifier (ID) and a password is displayed on the display 22 of the image forming apparatus 10. The user inputs his/her user ID and password and requests user authentication, and the image forming apparatus 10 inquires the management server whether to authenticate the user.

The management server receives the user ID and the password from the image forming apparatus 10 and determines whether the user ID and the password received from the image forming apparatus 10 match a user ID and a password registered in advance. If the user ID and the password received from the image forming apparatus 10 match a user ID and a password registered in advance, the management server notifies the image forming apparatus 10 that the user has been authenticated. If not, the management server notifies the image forming apparatus 10 that the user has not been authenticated. If the user has been authenticated, the management server also transmits, to the image forming apparatus 10, information regarding a history associated with the user ID of the user.

If the user has not been authenticated, the image forming apparatus 10 notifies the user that the user has not been authenticated, and asks the user to input a user ID and a password again. If the user has been authenticated, on the other hand, the image forming apparatus 10 displays, on the display 22, a list of file names obtained from an external computer or an external memory, that is, a file list, in accordance with an operation performed by the user. At this time, whether files are printable is determined, and whether the files have been printed is also determined on the basis of the history. Results of the determinations are indicated in the file list.

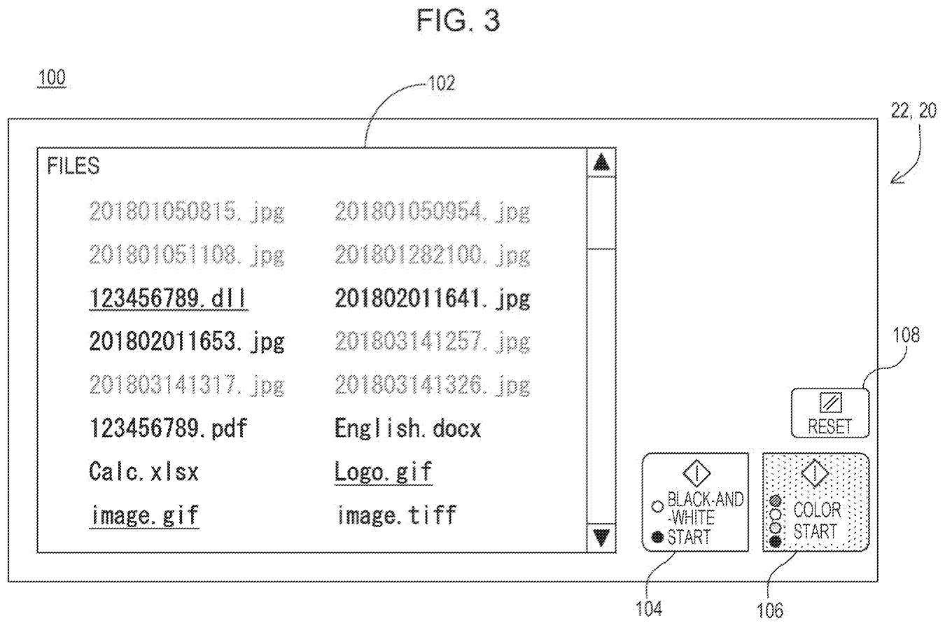

FIG. 3 is a diagram illustrating an example of a file list screen 100 according to the first embodiment. The file list screen 100 is displayed on the display 22. The file list screen 100 includes a display area 102 in which a file list is displayed. A black-and-white start key 104, a color start key 106, and a reset key 108 are provided to the right of the display area 102.

In the display area 102, file names corresponding to one or more files stored in a memory of an external computer or an external memory are displayed as a list. In the example illustrated in FIG. 3, file names of unprintable files are underscored, and file names of printed files are grayed out. Before an image of the display area 102 is drawn or generated, whether files are printable and whether files have been printed are determined.

The black-and-white start key 104 is a software key for performing black-and-white printing. Even if a file is a color image, therefore, black-and-white printing is performed when the black-and-white start key 104 has been pressed. The color start key 106 is a software key for performing color printing. Even when the color start key 106 has been pressed, however, black-and-white printing is performed if a file is a black-and-white image. The reset key 108 is a software key for canceling selection of a file name.

The file list screen 100 illustrated in FIG. 3 is an example, and as described above, unprintable files, printable files, and/or printed files may be indicated in various manners.

The user selects a file to be printed by touching a file name of a printable file on the file list screen 100 and then requests printing. The user requests printing by touching the black-and-white start key 104 or the color-start key 106. Whether the selected file has been printed is then determined.

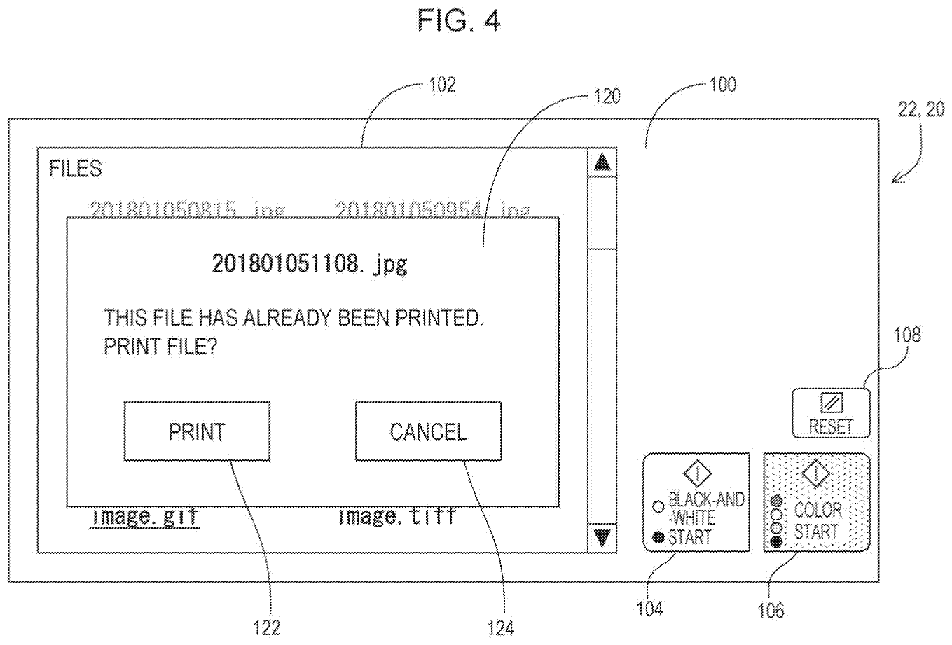

If the selected file has not been printed, printing is performed. If the selected file has been printed, the user is notified that the selected file has been printed, and asked whether to perform printing. As illustrated in FIG. 4, a dialog box 120 is displayed on the display 22 in front of the file list screen 100. In the dialog box 120, a key 122 for performing printing and a key 124 for canceling printing are displayed along with a message indicating that a printed file has been selected. The dialog box 120 illustrated in FIG. 4 is displayed, for example, when a file name “201801051108.jpg” has been selected on the file list screen 100 illustrated in FIG. 3 and the black-and-white start key 104 or the color start key 106 has been touched.

If the key 122 is touched in the dialog box 120 to perform printing, printing is performed. If the key 124 is touched to cancel printing, printing is canceled. If printing is performed, information regarding the printing of the file is added to a history. That is, the history is updated. In addition, the image forming apparatus 10 transmits information regarding the updated history to the management server when the service ends.

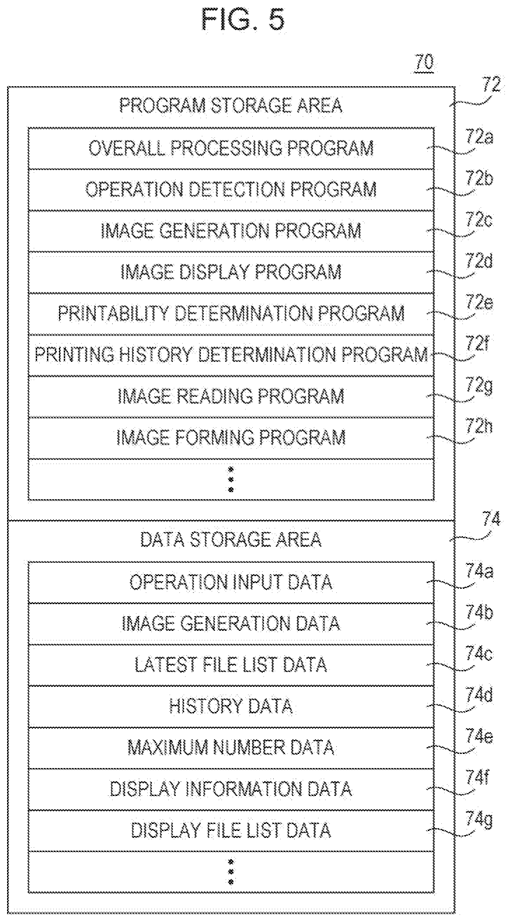

FIG. 5 is a diagram illustrating an example of a memory map 70 of the RAM 14 illustrated in FIG. 2. As illustrated in FIG. 7, the RAM 14 includes a program storage area 72 and a data storage area 74. The program storage area 72 of the RAM 14 stores control programs for controlling the image forming apparatus 10. The control programs include an overall processing program 72a, an operation detection program 72b, an image generation program 72c, an image display program 72d, a printability determination program 72e, a printing history determination program 72f, an image reading program 72g, and an image forming program 72h.

The overall process program 72a is a program for performing overall processing of the image forming apparatus 10. The operation detection program 72b is a program for detecting operations performed on the components of the image forming apparatus 10. The operation detection program 72b is, for example, a program for detecting operations performed on software keys included in various screens displayed on the display 22 by obtaining touch coordinate data output from the touch panel 20. The operation detection program 72b is also used to detect operation inputs from the operation buttons 26a.

The image generation program 72c is a program for generating display image data corresponding to various screens such as the file list screen 100 and the dialog box 120 using image generation data 74b, which will be described later, by controlling the GPU. The image display program 72d is a program for outputting, to the display 22, the display image data generated using the image generation program 72c.

The printability determination program 72e is a program for determining, when the file list screen 100 is displayed, whether files are printable. The printing history determination program 72f is a program for determining whether files have been printed. When whether files have been printed is determined, a part of the image forming program 72h is executed to perform a process for converting data regarding the files into RIP data.

The image reading program 72g is a program for reading (scanning) an image of a document conveyed by the ADF or set on the document platen and outputting an image signal, that is, read image data, corresponding to the read image by controlling the image reading unit 30.

The image forming program 72h is a program for forming, on a recording medium (sheet) an image corresponding to a file to be printed by controlling the image forming unit 32. Although not described in detail, when a process for forming an image is performed, data regarding a file is converted into RIP data.

Although not illustrated, the program storage area 72 stores other programs for performing various functions of the image forming apparatus 10.

The data storage area 74 of the RAM 14 stores operation input data 74a, the image generation data 74b, latest file list data 74c, history data 74d, maximum number-data 74e, display information data 74f, display file list data 74g, and the like.

The operation input data 74a is touch coordinate data and/or operation data detected (obtained) in accordance with the operation detection program 72b and stored in the data storage area 74 in chronological order.

The image generation data 74b is data, such as polygon data or texture data, for generating display image data. The image generation data 74b also includes image data regarding software keys.

The latest file list data 74c is data regarding a latest file list, which is a list of file names obtained from a memory of an external computer or an external memory. The history data 74d is information regarding a history corresponding to the user. In the history, file names of printed files are described. The history data 74d is read from the management server when a service starts and saved to the management server when the service ends.

The maximum number data 74e is value data regarding the total number of file names included in a file list. The display information data 74f is information or data regarding how file names are displayed when a display file list is displayed. In the first embodiment, the display information data 74f is data regarding information about a display color specified for file names of unprintable files and information about a display color specified for file names of printed files. That is, in the display information data 74f according to the first embodiment, information regarding specified display colors is associated with file names.

The display file list data 74g is image data regarding a display file list to be displayed in the display area 102 of the file list screen 100. In the first embodiment, the display file list data 74g is generated by modifying image data regarding a latest file list using the display information data 74f based on results of determinations whether files are printable and whether files have been printed.

Although not illustrated, the data storage area 74 stores other pieces of data used to execute the control programs and is provided with a timer (counter) and a register used to execute the control programs.

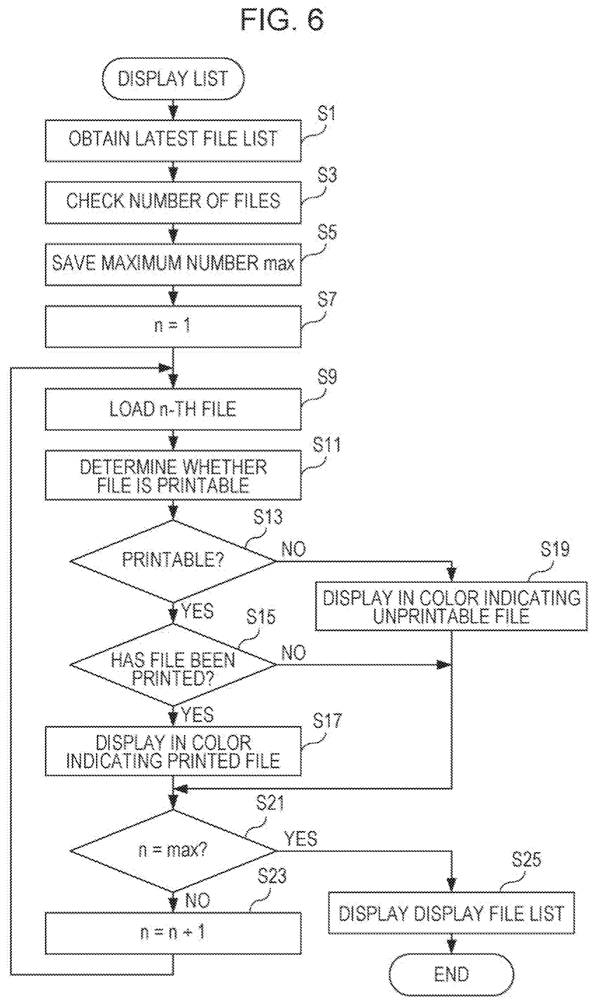

FIG. 6 is a flowchart illustrating an example of a process for displaying a list performed by the CPU 12 illustrated in FIG. 2. The process for displaying a list starts after use of the above-described service is requested and a user is successfully authenticated. After a user is successfully authenticated, the management server transmits history data corresponding to the authenticated user (user ID) to the image forming apparatus 10. The CPU 12 then starts the process for displaying a list as illustrated in FIG. 6. In step S1, the CPU 12 obtains data regarding a list of file names, that is, a latest file list, from a memory of an external computer or an external memory. The obtained data regarding the latest file list is stored in the RAM 14 as the latest file list data 74c.

In step S3, the CPU 12 checks the number of files. That is, the CPU 12 obtains a total number of file names described in the latest file list indicated by the latest file list data 74c. In step S5, the CPU 12 saves a maximum number max. That is, in step S5, value data regarding the total number of file names obtained in step S3 is stored in the RAM 14 as the maximum number data 74e.

In step S7, the CPU 12 sets an initial value for a variable n (n=1). The variable n is used to identify the file names on the file list individually. The file names described in the latest file list are sequentially referred to from a top in accordance with the variable n.

In step S9, the CPU 12 loads an n-th file. Although not illustrated in FIG. 5, a file corresponding to an n-th file name is read from the memory of the external computer or the external memory and stored in a buffer area of the RAM 14. Although detailed description is omitted, the file read in step S9 is deleted after a process for determining whether the file is printable is performed.

In step S11, the CPU 12 performs the process for determining whether the file loaded in step S9 is printable. At this time, the CPU 12 performs a process for converting data regarding the loaded file into RIP data. If the data regarding the loaded file is successfully converted into RIP data, it is determined that the file is printable. If the data regarding the loaded file is not converted into RIP data, it is determined that the file is unprintable.

In step S13, whether a result of the determination made in step S11 is positive is determined. If a result of step S13 is NO, that is, if it is determined in step S11 that the file is unprintable, the CPU 12 displays the file name of the n-th file in a color indicating an unprintable file, and the process proceeds to step S21. That is, in step S19, information indicating that the file name of the n-th file is displayed in the color indicating an unprintable file is added to the display information data 74f. That is, the display information data 74f is updated.

If the result of step S13 is YES, that is, if it is determined in step S11 that the file is printable, on the other hand, whether the file has been printed is determined in step S15. Here, the CPU 12 determines whether the n-th file has been printed by referring to a history indicated by the history data 74d. This holds true in a process for controlling printing (refer to FIG. 7), which will be described later.

If a result of step S15 is NO, that is, if the n-th file has not been printed, the process proceeds to step S21. If the result of step S15 is YES, that is, if the n-th file has been printed, on the other hand, the CPU 12 displays the file name of the n-th file in a color indicating a printed file, and the process proceeds to step S21. In step S17, information indicating that the file name of the n-th file is displayed in the color indicating a printed file is added to the display information data 74f. That is, the display information data 74f is updated.

In step S21, the CPU 12 determines whether the variable n is equal to the maximum number max. That is, the CPU 12 determines whether the determinations whether a file is printable and whether a file has been printed have been made for all the files.

If a result of step S21 is NO, that is, if the variable n is riot equal to the maximum number max, the CPU 12 increments the variable n by 1 (n=n+1) in step S23, and the process returns to step S9. If the result of step S21 is YES, that is, if the variable n is equal to the maximum number max, on the other hand, the CPU 12 displays the display file list in step S25 and ends the process for displaying a list. In step S25, the CPU 12 causes the GPU to generate image data that reflects results of the determinations whether the files are printable and whether the files have been printed, that is, the display file list data 74g, while using the latest file list data 74c and referring to the display information data 74f. The CPU 12 then causes the GPU to display the file list screen 100 such as that illustrated in FIG. 3 on the display 22 using the display file list data 74g.

FIG. 7 is a flowchart illustrating the process for controlling printing performed by the CPU 12 illustrated in FIG. 2. If the black-and-white start key 104 or the color start key 106 is touched on the file list screen 100 with a file name touched, that is, with a file selected, the CPU 12 starts the process for controlling printing. In step S51, the CPU 12 determines whether the selected file has been printed.

If a result of step S51 is NO, that is, if the file has not been printed, the process proceeds to step S59. If the result of step S51 is YES, on the other hand, the CPU 12 displays, in step S53 on the display 22, the dialog box 120 including a message indicating that the file has been printed. In step S55, the CPU 12 determines whether printing has been requested. That is, the CPU 12 determines whether the key 122 has been touched in the dialog box 120.

If a result of step S55 is YES, that is, if printing has been requested, the process proceeds to step S59. If the result of step S55 is NO, that is, if printing has not been requested, on the other hand, the CPU 12 determines in step S57 whether cancellation of printing has been requested. That is, the CPU 12 determines whether the key 124 has been touched in the dialog box 120.

If a result of step S57 is YES, that is, if cancellation of printing has been requested, the CPU 12 ends the process for controlling printing without performing printing. If the result of step S57 is NO, that is, if cancellation of printing has not been requested, on the other hand, the process returns to step S53.

In step S59, printing is performed. If the black-and-white start key 104 has been pressed, a process for forming a black-and-white image is performed. If the color start key 106 has been pressed, a process for forming a color image is performed.

In step S61, the history data 74d is updated, and the process for controlling printing ends. In step S61, information indicating that the file has been printed is added to the history data 74d. If the printing has been performed for a file that has already been printed in the past, step S61 is skipped.

According to the first embodiment, a file list indicating not only whether files are printable but also whether the files have been printed is displayed. Usability therefore improves.

Although file names of printed files are stored as a history in the first embodiment, other pieces of data may also be stored as histories. In another example, not only file names of printed files but also time information regarding printing and/or file sizes are stored as histories. In this case, if a printed file is updated, it can be determined that the file has not been printed.

Although file names are displayed in the first embodiment while reflecting a result of a determination whether files are printable, file names may be displayed in another manner, instead. File names may be sorted out in accordance with whether files are printable. In this case, for example, file names of printable files are displayed in an upper part of the display area 102 as a list, and file names of unprintable files are displayed in a lower part as a list. That is, file names of printable files are displayed at a top as a list, and a list of file names of unprintable files follows.

### Second Embodiment

An image forming apparatus 10 according to a second embodiment is the same as that according to the first embodiment except that the image forming apparatus 10 according to the second embodiment indicates whether files have been accessed instead of indicating whether files have been printed. Only differences will therefore be described, and redundant description is omitted or simplified.

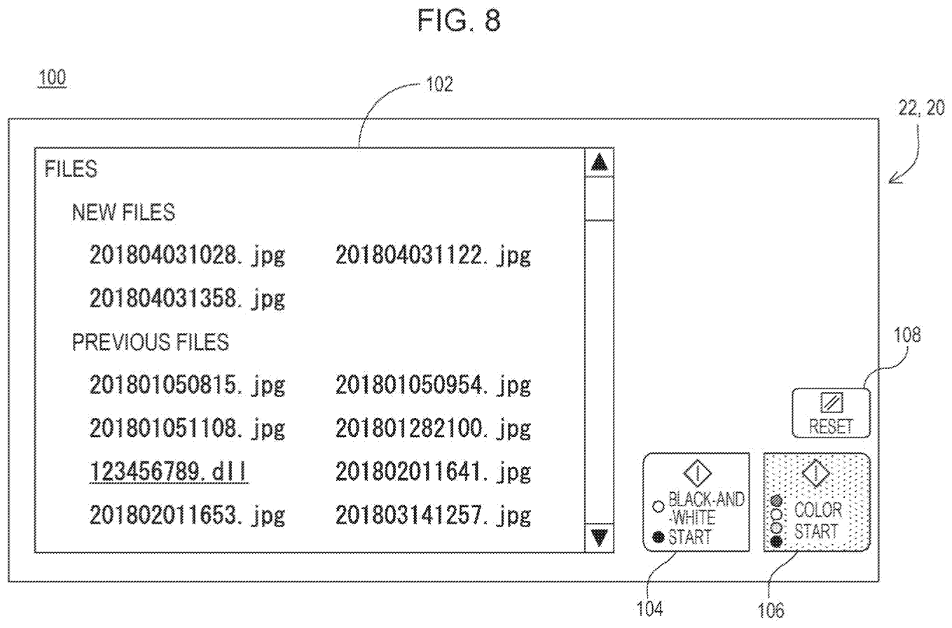

FIG. 8 is a diagram illustrating a file list screen 100 according to the second embodiment. As illustrated in FIG. 8, file names of new files and previous files are separately displayed in the display area 102 of the file list screen 100 according to the second embodiment. That is, in the second embodiment, newly added files are displayed at a top of a file list, that is, in an upper part of the display area 102.

A file list is displayed in this manner because it is likely that newly added files will be printed. That is, usability is taken into consideration here. Files are displayed as in the first embodiment such that whether the files are printable is indicated. Although a display file list is generated on the basis of a latest file list and file names of unprintable files are displayed in a different color in the first embodiment, a latest access list and a previous access list are generated and combined together in the second embodiment. When the latest access list and the previous access list are generated, file names are described in a color determined in accordance with a result of a determination whether files are printable.

When displaying a file list, the image forming apparatus 10 according to the second embodiment thus determines whether files are printable and whether the files have been accessed. Whether files described in a current file list have been accessed is determined on the basis of whether the files are described in a previous file list.

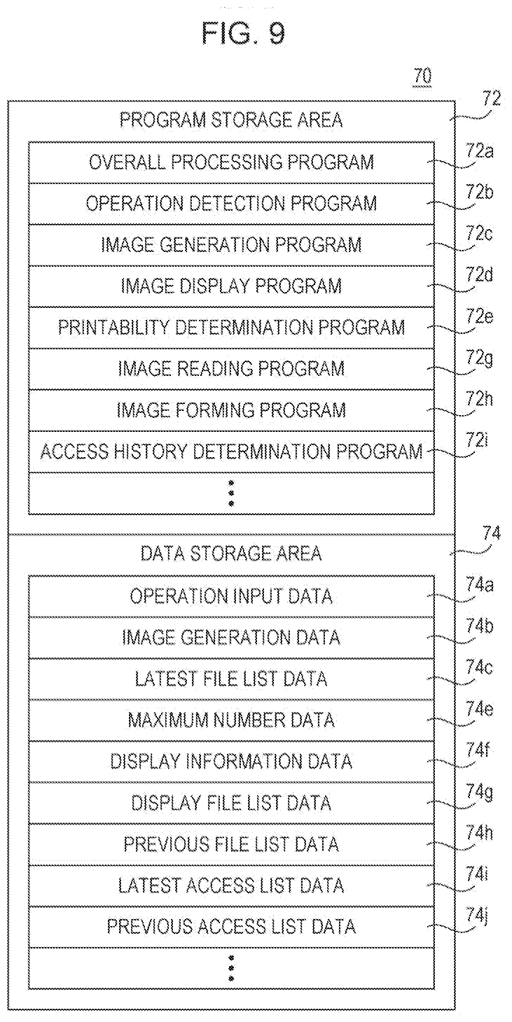

FIG. 9 is a diagram illustrating a memory map 70 of the RAM 14 according to the second embodiment. As illustrated in FIG. 9, the program storage area 72 of the RAM 14 stores an access history determination program 72i instead of the printing history determination program 72f in the second embodiment. The access history determination program 72i is used to determine whether files on a latest file list have been accessed.

In addition, in the second embodiment, the data storage area 74 of the RAM 14 stores previous file list data 74h instead of the history data 74d. The data storage area 74 of the RAM 14 also stores latest access list data 74i and previous access list data 74j.

The previous file list data 74h is data regarding a latest file list at a time of previous access. The previous file list data 74h is read from a server when a service starts. The latest file list data 74c is saved to the server as the previous file list data 74h when the service ends.

The latest access list data 74i is data regarding a latest access list, and the previous access list data 74j is data regarding a previous access list. The latest access list is a list of file names of files added between previous access and current access. The previous access list is a list of file names of files included in a latest file list at a time of previous access.

The latest access list data 74i and the previous access list data 74j are data for generating the display file list data 74g. Whether files have been access is determined in accordance with the access history determination program 72i. File names of files that have not been accessed are described in a latest access list, and file names of files that have been accessed are described in a previous access list. When the file list screen 100 illustrated in FIG. 8 is displayed, a display file list is generated by combining a previous access list with a latest access list at an end of the latest access list.

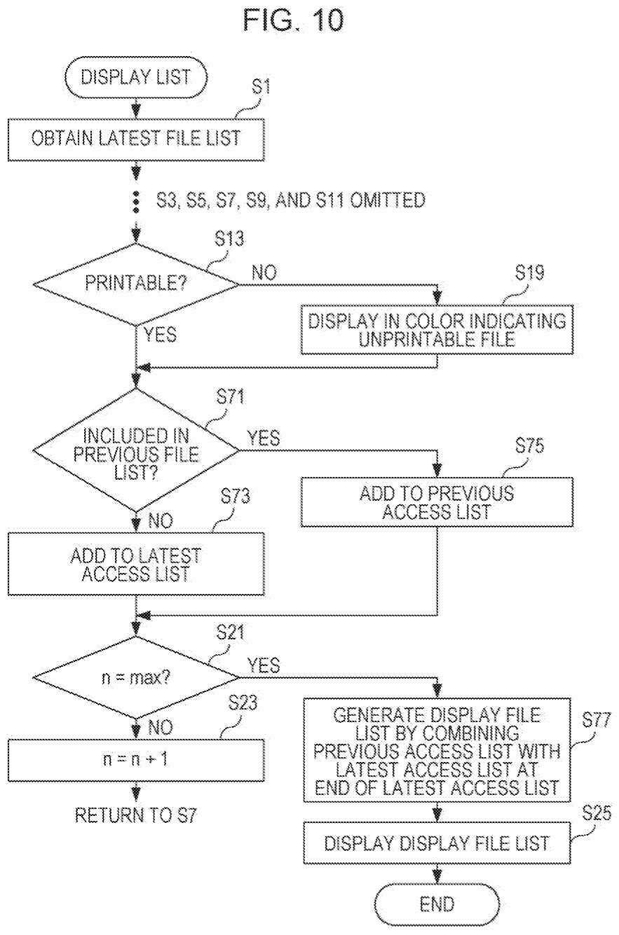

FIG. 10 is a flowchart illustrating a process for displaying a list according to the second embodiment. The process for displaying a list illustrated in FIG. 10 is obtained by modifying a part of the process for displaying a list according to the first embodiment illustrated in FIG. 6. More specifically, steps S15 and S17 are removed, and steps S71, S73, and S75 are provided between steps S13 and S21. Step S77 is provided between steps S21 and S25. The process for displaying a list according to the second embodiment will be described hereinafter. Differences from the first embodiment will be described in detail.

The process for displaying a list according to the second embodiment starts after use of the above-described service is requested, a user is successfully authenticated, and the previous file list data 74h is obtained from the management server.

In the process for displaying a list according to the second embodiment illustrated in FIG. 10, steps S1 to S13 and S19 are the same as those described in the first embodiment, and redundant description thereof is omitted.

If the result of step S13 is YES, or if the result of step S13 is NO and step S19 is performed, the CPU 12 refers to the previous file list data 74h and determines in step S71 whether a file name of an n-th file is included in a previous file list.

If a result of step S71 is NO, that is, if the file name of the n-th file is not included in the previous file list, the CPU 12 adds the file name of the n-th file to a latest access list in step S73, and the process proceeds to step S21. The latest access list data 74i is updated when step S73 is performed. In addition, file names displayed in step S19 in a color indicating unprintable files are described in the latest access list in the color when step S73 is performed. At this time, information regarding the color is added to the display information data 74f and associated with the file names. The same holds for step S75, which will be described later.

Although not illustrated, the latest access list is initialized when the process for displaying a list starts. That is, the CPU 12 stores, in the RAM 14, the latest access list data 74i in which nothing is described. The same holds for the previous access list, which will be described later.

If the result of step S71 is YES, that is, if the file name of the n-th file is included in the previous file list, on the other hand, the CPU 12 adds the file name of the n-th file to the previous access list in step S75, and the process proceeds to step S21. The previous access list data 74j is updated when step S75 is performed.

If the variable n and the maximum number max match, the result of step S21 becomes YES, and the CPU 12 generates a display file list in step S77 by combining the previous access list with the latest access list at an end of the latest access list. At this time, the display file list data 74g is stored in the RAM 14.

In the image forming apparatus 10 according to the second embodiment, if a file name of a desired file is touched on the file list screen 100 and then the black-and-white start key 104 or the color start key 106 is touched, the file corresponding to the touched file name is printed.

According to the second embodiment, a file list indicating not only whether files are printable but also whether the files have been accessed is displayed. When a newly added file is to be printed, therefore, the user can easily find a desired file. That is, usability improves.

When file names of printable files and unprintable files are sorted out in the second embodiment, the files are sorted out separately in a latest access list and a previous access list, and then the lists are combined together.

### Third Embodiment

An image forming apparatus 10 according to the third embodiment is the same as that according to the first embodiment except that the image forming apparatus 10 according to the third embodiment displays file names of unprintable files whose file formats can be converted into printable file formats such that it is indicated that the files can be printed if the file formats are converted, instead of determining whether files have been printed and displaying file names of printed files in a different color. Redundant description, therefore, is omitted.

In the third embodiment, image files in unprintable file formats are converted into image files in printable file formats using a computer (hereinafter referred to as a “conversion server”) in the network. Access information regarding the conversion server that provides a service for converting a file format is registered in the image forming apparatus 10 in advance. A file determined to be unprintable is transmitted to the conversion server, converted into a file in a printable file format, and sent back.

The image forming apparatus 10 stores in advance file formats convertible by the conversion computer and determines whether unprintable image files can be printed by converting file formats of the unprintable image files.

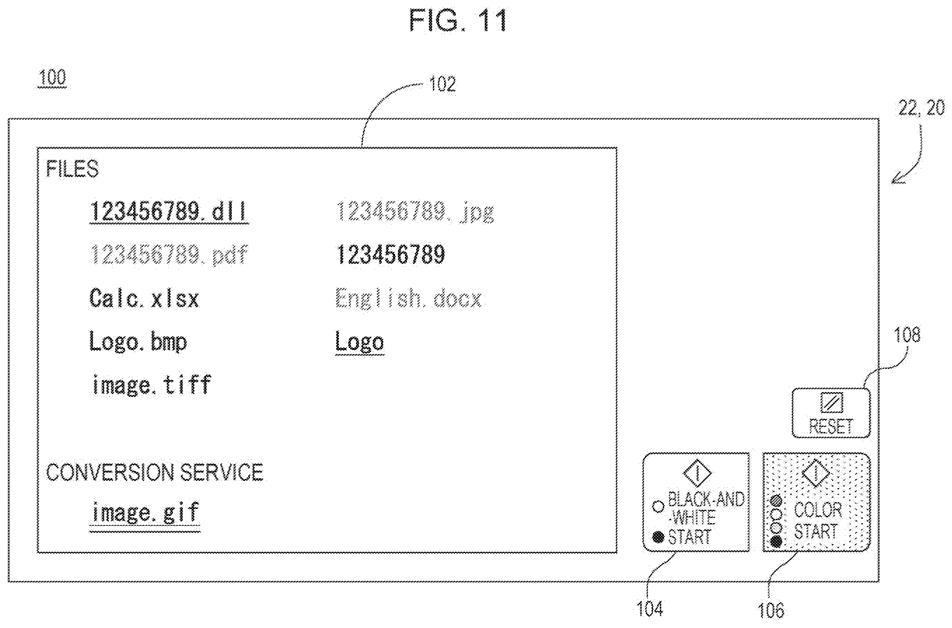

FIG. 11 is a diagram illustrating a file list screen 100 according to the third embodiment. As illustrated in FIG. 11, a file name of a file whose file format can be converted into a printable file format is displayed on the file list screen 100 according to the third embodiment in a file list of a conversion service. In the example illustrated in FIG. 11, a file name “image.gif” is described in the file list of the conversion service. That is, although the image forming apparatus 10 according to the third embodiment does not print files in graphics interchange format (GIF), the image forming apparatus 10 can convert such files if the file format of the files is converted into a printable file format (e.g., bitmap (BMP) file format). File names of files whose file formats can be converted into printable file formats are displayed in a color indicating printable files. In FIG. 11, the color indicating printable files is indicated by a double underline.

The color indicating printable files, however, need not be used, and an icon indicating printable files may be used, instead.

Although not illustrated, the image forming apparatus 10 according to the third embodiment stores a program for determining whether conversion into printable file formats is possible and a program for changing a color of file names of files whose file formats can be converted into printable file formats instead of the printing history determination program 72f.

Although detailed description is omitted, file formats are changed if printing of corresponding files is actually requested.

In the image forming apparatus 10 according to the third embodiment, if a file name of a desired file is touched on the file list screen 100 and then the black-and-white start key 104 or the color start key 106 is touched, the file corresponding to the touched file name is printed.

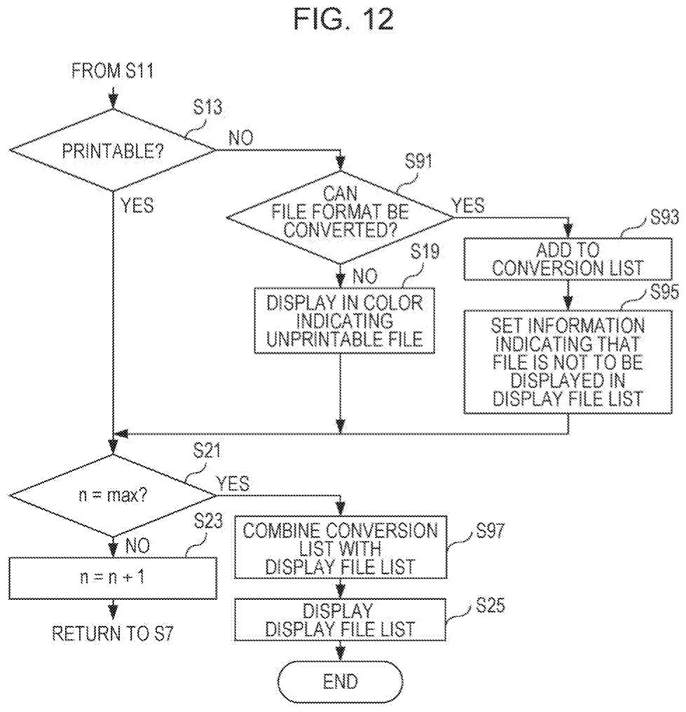

FIG. 12 is a flowchart illustrating a part of a process for displaying a list according to the third embodiment. The process for displaying a list according to the third embodiment is obtained by modifying a part of the process for displaying a list according to the first embodiment. More specifically, steps S15 and S17 are removed, step S91, in which a determination is made, is provided between steps S13 and S19, and if a result of step S91 is YES, steps S93 and S95 are performed. Step S97 is also provided between steps S21 and S25.

Because a history is not used in the third embodiment, the management server performs only authentication. The same holds for fourth to eighth embodiments, which will be described later.

As illustrated in FIG. 12, if a file is unprintable, the result of step S13 becomes NO, and the CPU 12 determines in step S91 whether a file format of the file can be converted. If a result of step S91 is NO, that is, if it is difficult to convert the file format, the process proceeds to step S19. If the result of step S91 is YES, that is, if the file format can be converted, on the other hand, the CPU 12 adds the file to the conversion list in step S93. In step S95, the CPU 12 sets information indicating that the file is not to be displayed in the display file list, and the process proceeds to step S21. Results of steps S93 and S95 are added to the display information data 74f.

If the variable n and the maximum number max match, the result of step S21 becomes YES, and the CPU 12 combines the conversion list with the display file list in step S97. The process then proceeds to step S25. That is, in step S97, the display file list is updated.

Although not illustrated, the conversion list is initialized in the third embodiment when the process for displaying a list starts.

According to the third embodiment, not only whether files are printable but also files in file formats that are unprintable by the image forming apparatus 10 but that becomes printable if the file formats of the files are converted are indicated. As a result, usability improves.

The modification employed in the third embodiment may be applied to the second embodiment. More specifically, in the flowchart of FIG. 10, the determination in step S91 is made between steps S13 and S19, and if the result of step S91 is YES, steps S93 and S95 are performed. In step S77, a previous access list is combined with a latest access list at an end of the latest access list, and a conversion list is combined with the previous access list at an end of the previous access list.

### Fourth Embodiment

An image forming apparatus 10 according to the fourth embodiment is the same as that according to the first embodiment except that the image forming apparatus 10 according to the fourth embodiment displays expenses for printing instead of determining whether files have been printed and displaying file names of printed files in a different color. Redundant description, therefore, is omitted.

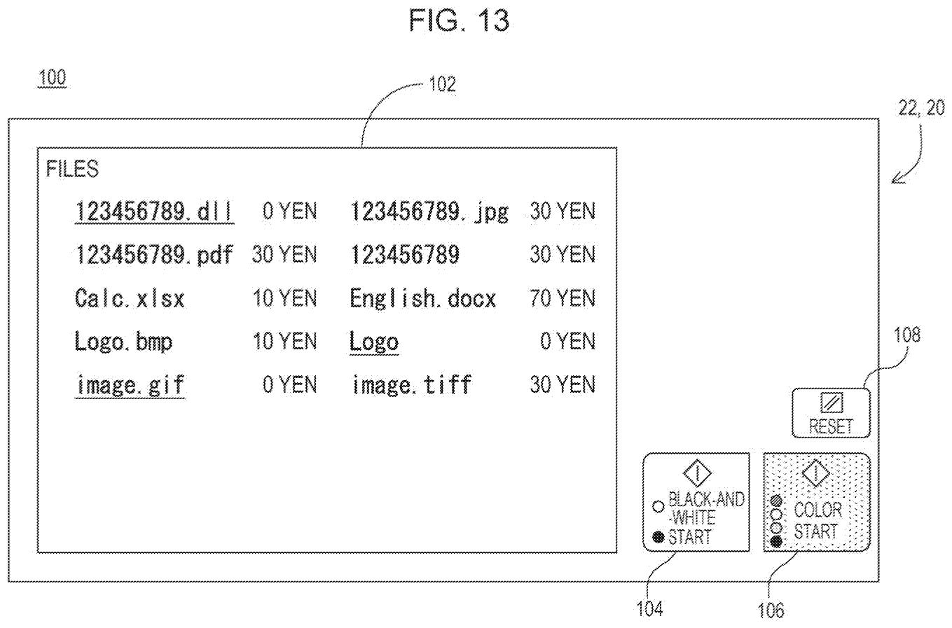

FIG. 13 is a diagram illustrating a file list screen 100 according to the fourth embodiment. As illustrated in FIG. 13, expenses for printing are displayed beside file names in the fourth embodiment. Since the file list screen 100 is displayed before printing, expenses caused when color printing is performed are calculated and displayed for color documents and expenses caused when black-and-white printing is performed are calculated and displayed for black-and-white documents.

The image forming apparatus 10 according to the fourth embodiment determines whether each file is printable and, if determining that the file is printable, calculates an expense for printing on the basis of types of document and the number of pages. The types of document include color/black-and-white and a sheet size. The types of document and the number of documents can be identified when a file is converted into RIP data in order to determine whether the file is printable. If expenses are stored in advance for each sheet size on the basis of color or black-and-white printing, expenses for the printing can be calculated by multiplying a corresponding expense by the number of pages.

If the image forming apparatus 10 determines that a file is unprintable, the image forming apparatus 10 determines an expense for printing as 0 yen.

Although not illustrated, the image forming apparatus 10 according to the fourth embodiment stores a program for calculating expenses for printing instead of the printing history determination program 72f.

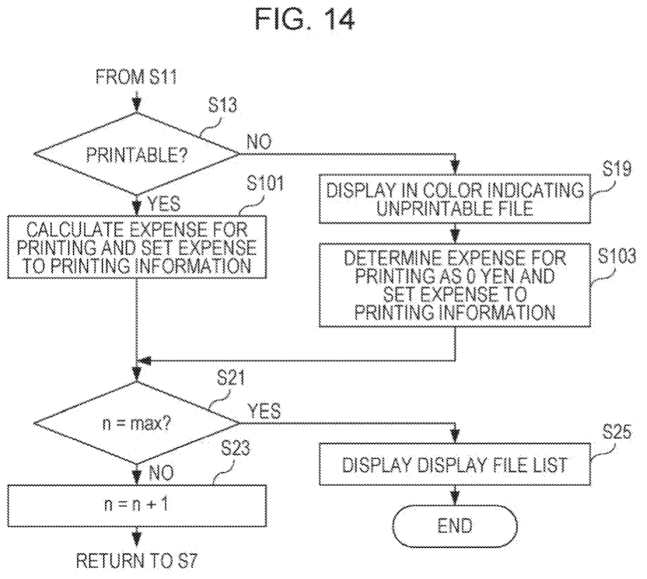

FIG. 14 is a flowchart illustrating a part of a process for displaying a list according to the fourth embodiment. The process for displaying a list according to the fourth embodiment is obtained by modifying a part of the process for displaying a list according to the first embodiment. More specifically, steps S15 and S17 are removed, step S101 is provided between steps S13 and S21, and step S103 is provided between steps S19 and S21.

As illustrated in FIG. 14, if a file is printable, the result of step S13 becomes YES, and the CPU 12 calculates an expense for printing and sets the expense to printing information in step S101. The process then proceeds to step S21. If a file is unprintable, on the other hand, the result of step S13 becomes NO, and step S19 is performed. In step S103, the CPU 12 determines an expense for printing as 0 yen and sets the expense to printing information, and the process proceeds to step S21. That is, in steps S101 and S103, a calculated or determined expense is added to the display information data 74f and associated with a file name. In the fourth embodiment, when image data regarding a display file list is generated in step S25, expenses are drawn beside file names.

According to the fourth embodiment, not only whether files are printable is indicated but also expenses for printing are displayed. The user can therefore learn expenses for printing in advance. When the image forming apparatus 10 according to the fourth embodiment is installed in a convenience store, a supermarket, a public facility, or the like, therefore, the user can learn an expense for printing before performing printing. That is, usability improves.

Although an expense for color printing is calculated for a color document in the fourth embodiment, both an expense for color printing and an expense for black-and-white printing may be calculated and displayed, instead.

The modification employed in the fourth embodiment may be applied to the second and third embodiments. If the modification is applied to the second embodiment, step S101 is provided between steps S13 and S71 illustrated in FIG. 10, and step S103 is provided between steps S19 and S71 illustrated in FIG. 10. If the modification is applied to the third embodiment, step S101 is provided between steps S13 and S21 illustrated in FIG. 12, and step S103 is provided between steps S19 and S21 illustrated in FIG. 12. If the modification is applied to the third embodiment, however, files whose file formats can be converted into printable file formats may be converted after the result of S91 becomes YES and may then be further converted into RIP data in order to calculate and display expenses for printing.

### Fifth Embodiment

An image forming apparatus 10 according to the fifth embodiment is the same as that according to the first embodiment except that the image forming apparatus 10 according to the fifth embodiment classifies file names of files including positional information into different places indicated by the positional information and displays the file names, instead of determining whether files have been printed and displaying file names of printed files in a different color. Redundant description, therefore, is omitted.

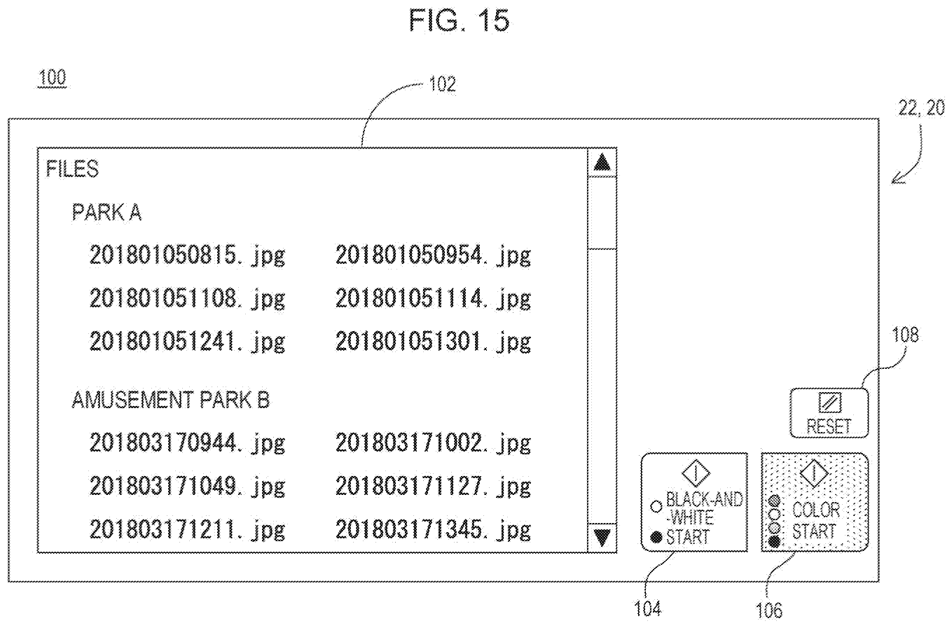

FIG. 15 is a diagram illustrating a file list screen 100 according to the fifth embodiment. As illustrated in FIG. 15, file names are classified into different places and displayed on the file list screen 100 according to the fifth embodiment. Although not illustrated, if the display area 102 is scrolled, a list of files that does not include positional information (hereinafter referred to as a “non-place-specific list”) is described below a list of files classified into different places (hereinafter referred to as a “place-specific list”).

Files of images captured by digital cameras, smartphones, and feature phones having a global positioning system (GPS) function, for example, include positional information, that is, information regarding latitudes and longitudes. Places can be identified from the positional information using a map application or the like. The map application is provided by a certain server in the network. If the image forming apparatus 10 transmits positional information to the certain server, for example, the certain server identifies a place from the positional information and transmits information regarding the identified place to the image forming apparatus 10.

Although not illustrated, the image forming apparatus 10 according to the fifth embodiment stores a program for identifying a place on the basis of positional information instead of the printing history determination program 72f.

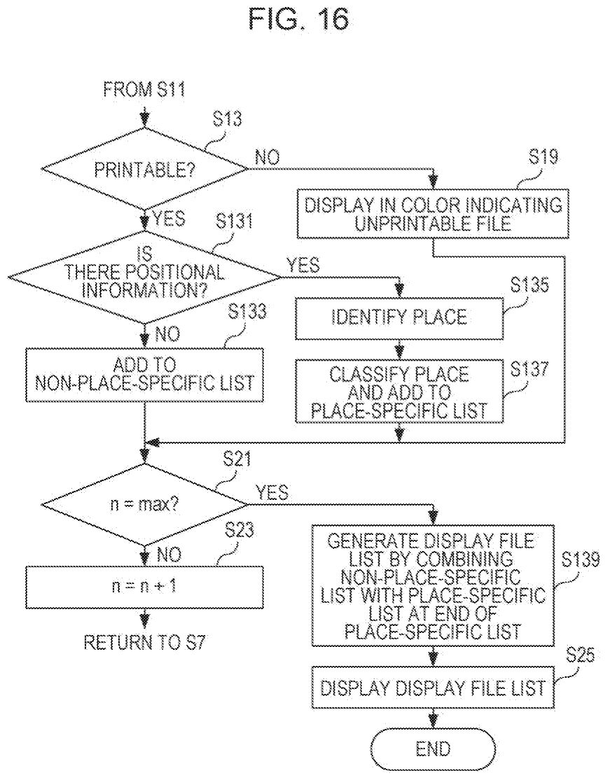

FIG. 16 is a flowchart illustrating a part of a process for displaying a list according to the fifth embodiment. The process for displaying a list according to the fifth embodiment is obtained by modifying a part of the process for displaying a list according to the first embodiment. More specifically, steps S15 and S17 are removed, steps S131, S133, S135, and S137 are provided between steps S13 and S21, and step S139 is provided between steps S21 and S25.

As illustrated in FIG. 16, if a file is printable, the result of step S13 becomes YES, and the CPU 12 determines in step S131 whether there is positional information. That is, the CPU 12 determines whether an n-th file includes positional information.

If a result of step S131 is NO, that is, if the n-th file does not include positional information, the CPU 12 adds a file name of the n-th file to the non-place-specific list in step S133, and the process proceeds to step S21.

If the result of step S131 is YES, that is, if the n-th file includes positional information, on the other hand, the CPU 12 identifies a place in step S135. Here, the CPU 12 transmits the positional information to the certain server and receives information regarding a place from the certain server. In step S137, the CPU 12 adds the file name of the n-th file to the place-specific list, and the process proceeds to step S21.

If the variable n and the maximum number max match, the result of step S21 becomes YES, and the CPU 12 combines the non-place-specific list with the place-specific list at an end of the place-specific list in step S139 to generate a display file list. The process then proceeds to step S25.

Although not illustrated, the place-specific list and the non-place-specific list are initialized at a beginning of the process for displaying a list according to the fifth embodiment.

According to the fifth embodiment, not only whether files are printable is indicated but also files including positional information are classified into different places and displayed. As a result, photographs taken at a single place can be printed at once, which improves usability.

The modification employed in the fifth embodiment can be applied to the second embodiment. More specifically, in the flowchart of FIG. 10, steps S131 to S137 may be performed between steps S73 and S21 and between steps S75 and S21, and the latest access list and the previous access list may be replaced by the place-specific list and the non-place-specific list.

The modification employed in the fifth embodiment may also be applied to the third and fourth embodiments. If the modification is applied to the third embodiment, steps S131 to S137 are performed between steps S13 and S21 illustrated in FIG. 12, and the place-specific list, the non-place-specific list, and the conversion list are combined together in step S97 to generate a display file list. If the modification is applied to the fourth embodiment, steps S131 to S137 are performed between steps S13 and S101 or between steps S101 and S21 illustrated in FIG. 14, and step S139 is performed between steps S21 and S25.

### Sixth Embodiment

An image forming apparatus 10 according to the sixth embodiment is the same as that according to the first embodiment except that the image forming apparatus 10 according to the sixth embodiment indicates types of files with a ruler instead of determining whether files have been printed and displaying file names of printed files in a different color. Redundant description, therefore, is omitted.

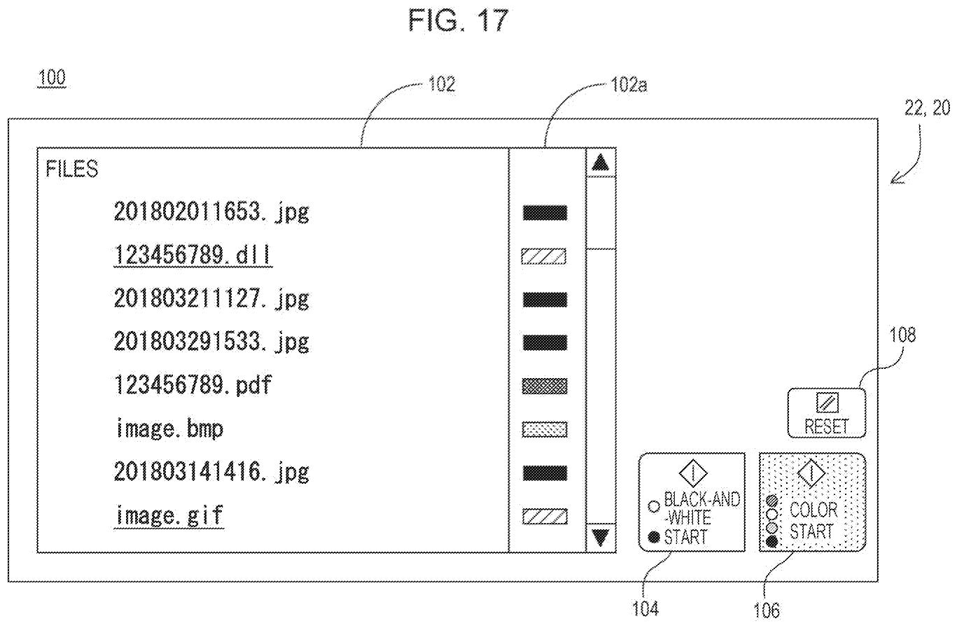

FIG. 17 is a diagram illustrating a file list screen 100 according to the sixth embodiment. As illustrated in FIG. 17, a ruler 102a is displayed in a right part of the display area 102 on the file list screen 100 according to the sixth embodiment. The ruler 102a includes a plurality of indicators, which are displayed in colors corresponding to types of files having file names displayed beside the indicators. In FIG. 17, the colors of the indicators included in the ruler 102a are expressed by different densities and a pattern.

In the sixth embodiment, therefore, a program for determining types of printable files and generating a ruler list in accordance with a result of a determination instead of the printing history determination program 72f.

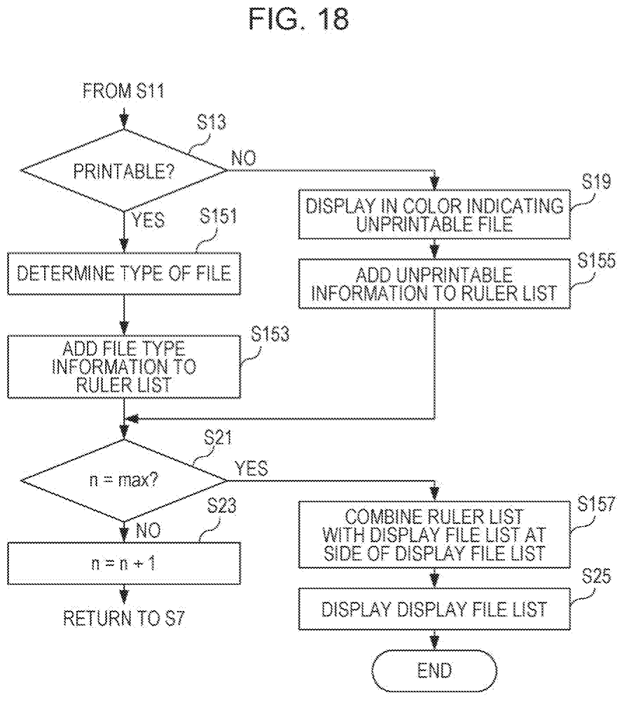

FIG. 18 is a flowchart illustrating a part of a process for displaying a list according to the sixth embodiment. The process for displaying a list according to the sixth embodiment is obtained by modifying a part of the process for displaying a list according to the first embodiment. More specifically, steps S15 and S17 are removed, steps S151 and S153 are provided between steps S13 and S21, step S155 is provided between steps S19 and S21, and step S157 is provided between steps S21 and S25.

As illustrated in FIG. 18, if a file is printable, the result of step S13 becomes YES, and the CPU 12 determines a type of file in step S151. In the sixth embodiment, the CPU 12 determines the type of file on the basis of an extension of the file. In step S153, the CPU 12 adds file type information to a ruler list, and the process proceeds to step S21. In step S153, the CPU 12 displays an indicator of the ruler 102a at a position corresponding to a file name of the file in a color corresponding to the type of file determined in step S151 in the ruler list.

If the file is unprintable, on the other hand, the result of step S13 becomes NO, and step S19 is performed. In step S155, the CPU 12 adds unprintable information to the ruler list, and the process proceeds to step S21. In step S155, the CPU 12 displays an indicator of the ruler 102a at the position corresponding to the file name of the file in a color corresponding to an unprintable file in the ruler list.

If the variable n and the maximum number max match, the result of step S21 becomes YES, and the CPU 12 combines the ruler list with a display file list at a side of the display file list in step S157. The process then proceeds to step S25.

According to the sixth embodiment, not only whether files are printable is indicated but also the ruler 102a is displayed. Types of files can therefore be identified on the basis of colors used in the ruler 102a. If a large number of files are included in a list, therefore, the files can be narrowed down on the basis of a color used in the ruler 102a, and a desired file can be found relatively easily, which improves usability.

The modification employed in the sixth embodiment can be applied to the second embodiment. More specifically, in the flowchart of FIG. 10, steps S151 and S153 are performed between steps S73 and S21 and between steps S75 and S21, and the latest access list and the previous access list are added to the ruler list. In addition, step S155 is performed between steps S19 and S71. In step S77, the ruler list is combined with a generated display file list at a side of the display file list.

The modification employed in the sixth embodiment can also be applied to the third to fifth embodiments. If the modification is applied to the third embodiment, steps S151 and S153 are performed between steps S13 and S21 illustrated in FIG. 12, and step S155 is performed between steps S19 and S21. Information indicating a converted file is added to the ruler list between steps S95 and S21. In step S97, the conversion list is combined with a display file list, and the ruler list is then combined with the display file list.

If the modification is applied to the fourth embodiment, steps S151 and S153 are performed between steps S13 and S101 or between steps S101 and S21 illustrated in FIG. 14, and step S155 is performed between steps S19 and S103 or between steps S103 and S21. The ruler list is combined with a display file list between steps S21 and S25.

If the modification is applied to the fifth embodiment, steps S151 and S153 are performed between steps S133 and S21 and between steps S137 and S21 illustrated in FIG. 16, and step S155 is performed between steps S19 and S21. In step S139, the ruler list is combined with a generated display file list.

### Seventh Embodiment

An image forming apparatus 10 according to the seventh embodiment is the same as that according to the first embodiment except that the image forming apparatus 10 according to the seventh embodiment translates file names and displays the translated file names instead of determining whether files have been printed and displaying file names of printed files in a different color. Redundant description, therefore, is omitted.

In the seventh embodiment, information regarding a language used is registered in the image forming apparatus 10 in advance, and file names written in languages different from the registered language are translated and displayed. The translation of file names is performed by a certain server that provides a translation service (hereinafter referred to as a “translation server”). That is, the image forming apparatus 10 determines whether file names need to be translated. If so, the image forming apparatus 10 transmits file names to be translated to the translation server and receives results of the translation from the translation server. The translated file names are drawn when the file list screen 100 is displayed.

In the seventh embodiment, therefore, a program for determining whether languages of file names are a registered language, that is, whether the file names need to be translated, and, if so, translating the file names is stored instead of the printing history determination program 72f. Since the translation server performs the translation as described above, file names to be translated are transmitted to the translation server and the translated file names are received from the translation server in this program.

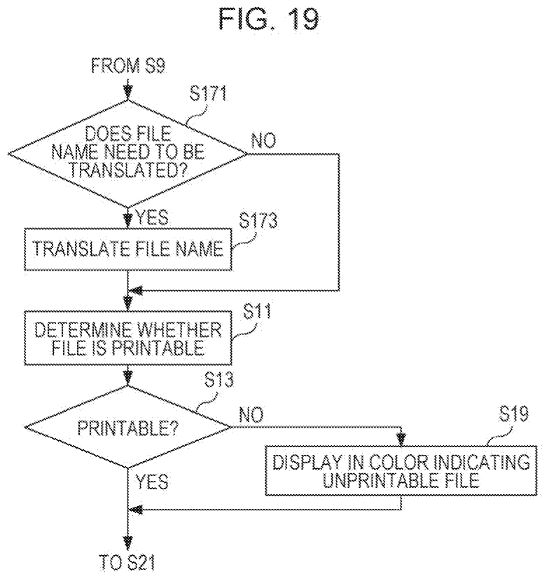

FIG. 19 is a flowchart illustrating a part of a process for displaying a list according to the seventh embodiment. The process for displaying a list according to the seventh embodiment is obtained by modifying a part of the process for displaying a list according to the first embodiment. More specifically, steps S15 and S17 are removed, and steps S171 and S173 are provided between steps S9 and S11.

The CPU 12 loads an n-th file and, as illustrated in FIG. 19, determines in step S171 whether a file name of the n-th file needs to be translated. If a result of step S171 is NO, that is, if the file name need not be translated, the process proceeds to step S11. If the result of step S171 is YES, on the other hand, the file name of the n-th file is translated in step S173, and the process proceeds to step S11. That is, in step S173, the CPU 12 transmits the file name to be translated to the translation server, receives the translated file name from the translation server, and adds information regarding the translation file name to the display information data 74f while associating the information with the file name of the n-th file. If the translated file name is described in the display information data 74f when the file list screen 100 is displayed, the translated file name is drawn.

According to the seventh embodiment, not only whether files are printable is indicated but also file names written in languages different from a language used are translated and displayed. As a result, even if file names are written in languages different from a language used, the user can understand the file names. The user therefore need not translate file names, which improves usability.

The modification employed in the seventh embodiment can be applied to the second to sixth embodiments. More specifically, in each of the second to sixth embodiments, steps S171 and S173 are performed between steps S9 and S1 as described in the seventh embodiment. The same holds for the eighth embodiment, which will be described hereinafter.

### Eighth Embodiment

An image forming apparatus 10 according to the eighth embodiment is the same as that according to the first embodiment except that the image forming apparatus 10 according to the eighth embodiment translates data in files and displays the data as a preview image instead of determining whether files have been printed and displaying file names of printed files in a different color. Redundant description, therefore, is omitted.

In the eighth embodiment, information regarding a language used is registered in the image forming apparatus 10 in advance. If data in printable files is text data and text is written in languages different from the registered language after whether files are printable is determined, the text is translated and displayed as a preview image. Text data in files is translated by a certain server that provides a translation service (hereinafter referred to as a “translation server”). That is, the image forming apparatus 10 determines whether data in files can be translated. If so, the image forming apparatus 10 transmits the files including the translatable text to the translation server and receives the files including the translated text. When the file list screen 100 is displayed, a preview image is drawn along with file names of the translated files.

In the eighth embodiment, therefore, a program for determining whether data in files can be translated and, if so, translating text included in the files and displaying the text as a preview image is stored instead of the printing history determination program 72f. Since the translation server performs the translation as described above, files including translatable text are transmitted to the translation server and the translated files are received from the translation server in this program. If data in files is not text data or if data in file is text data but need not be translated, it is determined that translation is not possible, and text indicating that there is no preview image is displayed along with file names in this program.

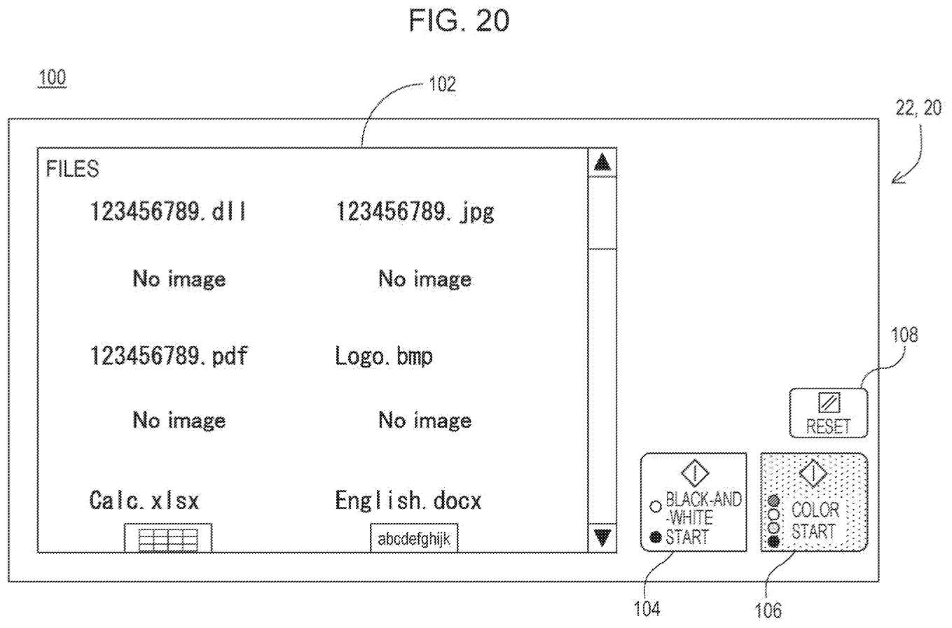

FIG. 20 is a diagram illustrating a file list screen 100 according to the eighth embodiment. As illustrated in FIG. 20, preview images of translated files are displayed under corresponding file names on the file list screen 100 according to the eighth embodiment. The preview images displayed in the display area 102 are first pages of the files, but pages may be turned by touching the preview images. For files that have not been translated, text indicating that there is no preview image is displayed.

In the eighth embodiment, as in the first embodiment, the user selects a file to be printed by touching a file name of a printable file on the file list screen 100, and requests printing. The user requests printing by touching the black-and-white start key 104 or the color start key 106. If printing is requested, whether a selected file has been translated is determined.

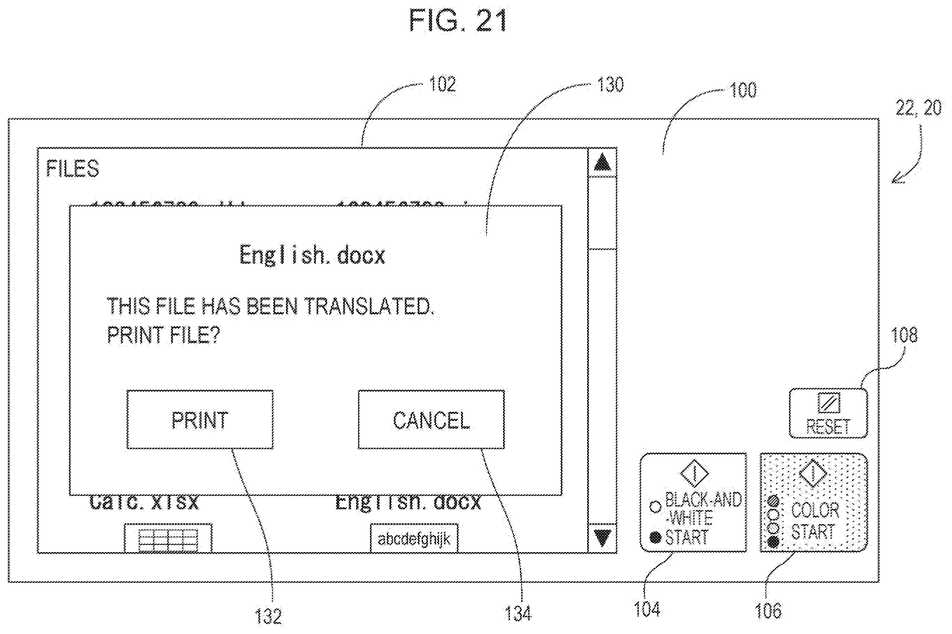

If the selected file has not been translated, printing is performed. If the selected file has been translated, on the other hand, the user is notified that the file has been translated and asked whether to print the file. As illustrated in FIG. 21, a dialog box 130 is displayed on the display 22 in front of the file list screen 100. In the dialog box 130, a key 132 for performing printing and a key 134 for canceling printing are displayed along with a message indicating that a translated file has been selected. The dialog box 130 illustrated in FIG. 21 is displayed, for example, when a file name “English.docx” has been selected on the file list screen 100 illustrated in FIG. 20 and the black-and-white start key 104 or the color start key 106 has been touched.

If the key 132 is touched in the dialog box 130 to perform printing, printing is performed. If the key 134 is touched to cancel printing, printing is canceled.

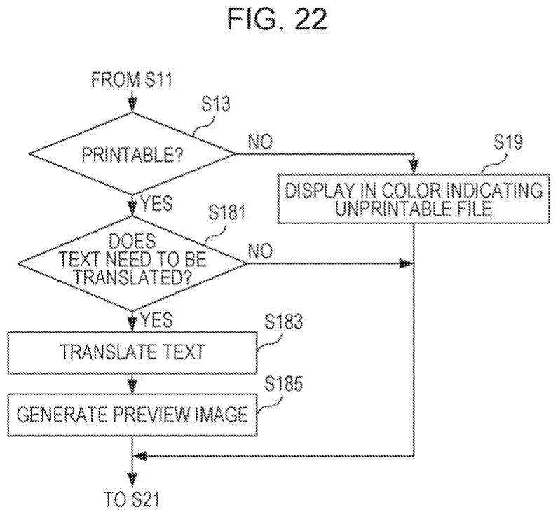

FIG. 22 is a flowchart illustrating a part of a process for displaying a list according to the eighth embodiment. The process for displaying a list according to the eighth embodiment is obtained by modifying a part of the process for displaying a list according to the first embodiment. More specifically, steps S15 and S17 are removed, and steps S181, S183, and S185 are provided between steps S13 and S21.

As illustrated in FIG. 22, if a file is printable, the result of step S13 becomes YES, and the CPU 12 determines in step S181 whether text needs to be translated. If a result of step S181 is NO, that is, if the text need not be translated, the process proceeds to step S21. If the result of step S181 is YES, that is, if the text needs to be translated, the text is translated in step S183 and a preview image of the translated file is generated in step S185. The process then proceeds to step S21. That is, in step S183, the CPU 12 transmits, to the translation server, the file including the text that needs to be translated and receives, from the translation server, the file including the translated text. After generating a preview image in step S185, the CPU 12 adds the preview image to the display information data 74f while associating the preview image with a file name of the file. The preview image generated in step S185 is therefore drawn along with the file name when the file list screen 100 is displayed.

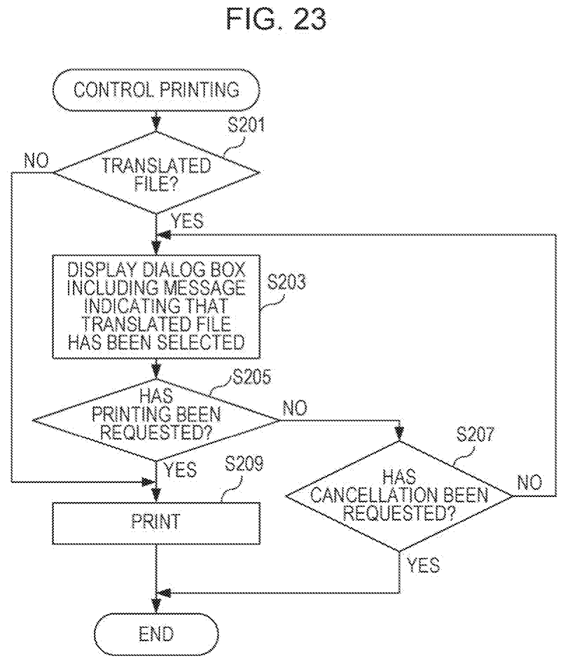

FIG. 23 is a flowchart illustrating a process for controlling printing performed by the CPU 12 according to the eighth embodiment. If the black-and-white start key 104 or the color start key 106 is touched after a file name is touched on the file list screen 100, that is, after a file is selected, the CPU 12 starts the process for controlling printing. In step S201, the CPU 12 determines whether the selected file is a translated file.

If a result of step S201 is NO, that is, if the selected file is not a translated file, the process proceeds to step S209. If the result of step S201 is YES, that is, if the selected file is a translated file, on the other hand, the CPU 12 displays, in step S203 on the display 22, the dialog box 130 including the message indicating that a translated file has been selected. In step S205, the CPU 12 determines whether printing has been requested. That is, the CPU 12 determines whether the key 132 has been touched in the dialog box 130.

If a result of step S205 is YES, that is, if printing has been requested, the process proceeds to step S209. If the result of step S205 is NO, that is, if printing has not been requested, on the other hand, the CPU 12 determines in step S207 whether cancellation has been requested. That is, the CPU 12 determines whether the key 134 has been touched in the dialog box 130.

If a result of step S207 is YES, that is, if cancellation has been requested, the CPU 12 ends the process for controlling printing without performing printing. If the result of step S207 is NO, that is, if cancellation has not been requested, on the other hand, the process returns to step S203.

In step S209, printing is performed, and the process for controlling printing ends. If the black-and-white start key 104 has been pressed, a black-and-white image is formed in step S209. If the color start key 106 has been pressed, a color image is formed in step S209.

According to the eighth embodiment, not only whether files are printable is indicate but also text in files written in languages different from a language used is translated and preview images are displayed. Even if files are created in languages different from a language used, therefore, the user can understand the content of the files. As a result, the user can easily select a file to be printed and need not translate the content of the files, which improves usability.

The modification employed in the eighth embodiment can be applied to the second to sixth embodiments. More specifically, in the second embodiment, steps S181 to S185 are performed between steps S13 and S71 illustrated in FIG. 10 or between steps S73 or S75 and S21 illustrated in FIG. 10.

In the third, fourth, and sixth embodiments, steps S181 to S185 are performed between steps S13 and S21 illustrated in FIGS. 12, 14, and 18, respectively.

In the fifth embodiment, steps S181 and S185 are performed between steps S13 and S131 illustrated in FIG. 16 or between steps S133 or S137 and S21 illustrated in FIG. 16.

Although the determination whether a file has been printed (S15) and the display of a file name of a printed file in a different color (S17) according to the first embodiment are removed in the second to eighth embodiments, the determination and the display may also be performed in the second to eighth embodiments, instead.

The values, the screens, and the specific components described in the above embodiments are examples, and may be modified for actual products. In addition, order in which the steps in the flowcharts referred to in the above embodiments are performed may be changed insofar as the same results can be obtained.

The present disclosure contains subject matter related to that disclosed in Japanese Priority Patent Application JP 2018-131559 filed in the Japan Patent Office on Jul. 11, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus that displays identification information regarding a plurality of files on a display unit and that outputs a file selected by a user, the image forming apparatus comprising:
a printing history determination unit that determines whether each of the plurality of files has been printed; and
a display control unit that displays, on the display unit, the identification information regarding each of the plurality of files, the identification information visually indicating a result of a determination made by the printing history determination unit.

2. An image forming apparatus that displays identification information regarding a plurality of files on a display unit and that outputs a file selected by a user, the image forming apparatus comprising:
an access history determination unit that determines whether each of the plurality of files has been accessed; and
a display control unit that displays, on the display unit, the identification information regarding each of the plurality of files, the identification information visually indicating a result of a determination made by the access history determination unit.

3. The image forming apparatus according to claim 1, further comprising:
a printability determination unit that determines whether each of the plurality of files is printable,
wherein the display control unit displays identification information regarding a file determined by the printability determination unit as printable and identification information regarding a file determined by the printability determination unit as unprintable in an identifiable manner.

4. The image forming apparatus according to claim 2, further comprising:
a printability determination unit that determines whether each of the plurality of files is printable,
wherein the display control unit displays identification information regarding a file determined by the printability determination unit as printable and identification information regarding a file determined by the printability determination unit as unprintable in an identifiable manner.

5. The image forming apparatus according to claim 1, further comprising:
a printability determination unit that determines whether each of the plurality of files is printable; and
a conversion unit that converts a format of a file determined by the printability determination unit as unprintable into a printable file format,
wherein the display control unit displays the identification information regarding each of the plurality of files, the identification information indicating that the conversion unit has converted the format into the printable file format.

6. The image forming apparatus according to claim 2, further comprising:
a printability determination unit that determines whether each of the plurality of files is printable; and
a conversion unit that converts a format of a file determined by the printability determination unit as unprintable into a printable file format,
wherein the display control unit displays the identification information regarding each of the plurality of files, the identification information indicating that the conversion unit has converted the format into the printable file format.

7. The image forming apparatus according to claim 1, further comprising:
a printability determination unit that determines whether each of the plurality of files is printable; and
an expense calculation unit that calculates an expense for printing a file determined by the printability determination unit as printable,
wherein the display control unit displays the expense calculated by the expense calculation unit along with identification information regarding the file.

8. The image forming apparatus according to claim 2, further comprising:
a printability determination unit that determines whether each of the plurality of files is printable; and
an expense calculation unit that calculates an expense for printing a file determined by the printability determination unit as printable,
wherein the display control unit displays the expense calculated by the expense calculation unit along with identification information regarding the file.

9. The image forming apparatus according to claim 1, further comprising:
a printability determination unit that determines whether each of the plurality of files is printable; and
a positional information determination unit that determines whether a file determined by the printability determination unit as printable includes positional information,
wherein the display control unit classifies the file determined by the positional information determination unit as including positional information in accordance with a place indicated by the positional information and displays the file.

10. The image forming apparatus according to claim 2, further comprising:
a printability determination unit that determines whether each of the plurality of files is printable; and
a positional information determination unit that determines whether a file determined by the printability determination unit as printable includes positional information,
wherein the display control unit classifies the file determined by the positional information determination unit as including positional information in accordance with a place indicated by the positional information and displays the file.

11. The image forming apparatus according to claim 1, further comprising:
a printability determination unit that determines whether each of the plurality of files is printable; and
a type determination unit that determines a type of a file determined by the printability determination unit as printable,
wherein the display control unit displays identification information regarding the file determined by the printability determination unit as printable with a ruler in accordance with the type of the file and identification information regarding a file determined by the printability determination unit as unprintable with a ruler as an unprintable type.

12. The image forming apparatus according to claim 2, further comprising:
a printability determination unit that determines whether each of the plurality of files is printable; and
a type determination unit that determines a type of a file determined by the printability determination unit as printable,
wherein the display control unit displays identification information regarding the file determined by the printability determination unit as printable with a ruler in accordance with the type of the file and identification information regarding a file determined by the printability determination unit as unprintable with a ruler as an unprintable type.

13. The image forming apparatus according to claim 1,
wherein the identification information regarding the plurality of files is file names,
the image forming apparatus further comprising:
an understandability determination unit that determines whether the user understands each of the file names; and
a file name changing unit that, if the understandability determination unit determines that the user does not understand a file name, changes the file name into a mode understandable by the user,
wherein the display control unit displays, if the file name changing unit changes a mode of the file name, the file name in the changed mode.

14. The image forming apparatus according to claim 2,
wherein the identification information regarding the plurality of files is file names,
the image forming apparatus further comprising:
an understandability determination unit that determines whether the user understands each of the file names; and
a file name changing unit that, if the understandability determination unit determines that the user does not understand a file name, changes the file name into a mode understandable by the user,
wherein the display control unit displays, if the file name changing unit changes a mode of the file name, the file name in the changed mode.

15. The image forming apparatus according to claim 1, further comprising:
a changeability determination unit that determines whether text in each of the plurality of files is changeable into a mode understandable by the user; and
a text changing unit that, if the changeability determination unit determines that text in a file is changeable into the mode understandable by the user, changes the text in the file into the mode understandable by the user,
wherein the display control unit displays, if the text changing unit changes a mode of the text in the file, the file in the changed mode as a preview image.

16. The image forming apparatus according to claim 2, further comprising:
a changeability determination unit that determines whether text in each of the plurality of files is changeable into a mode understandable by the user; and
a text changing unit that, if the changeability determination unit determines that text in a file is changeable into the mode understandable by the user, changes the text in the file into the mode understandable by the user,
wherein the display control unit displays, if the text changing unit changes a mode of the text in the file, the file in the changed mode as a preview image.

17. A method for controlling an image forming apparatus that displays identification information regarding a plurality of files on a display unit and that outputs a file selected by a user, the method comprising:
determining whether each of the plurality of files has been printed; and
displaying, on the display unit, the identification information regarding each of the plurality of files, the identification information visually indicating a result of a determination made by the printing history determination unit.

18. A method for controlling an image forming apparatus that displays identification information regarding a plurality of files on a display unit and that outputs a file selected by a user, the method comprising:
determining whether each of the plurality of files has been accessed; and
displaying, on the display unit, the identification information regarding each of the plurality of files, the identification information visually indicating a result of a determination made by the access history determination unit.
